(19) United States
(12) Patent Application Publication
(10) Pub. No.: US 2013/0091147 A1
(43) Pub. Date: Apr. 11, 2013

(54) METHOD AND SYSTEM OF EVALUATING THE IMPACT OF DISTRIBUTED DIGITAL CONTENT

(71) Applicant: SIMPLEREACH, INC., New York, NY (US)

(72) Inventors: EDWARD KIM, NEW YORK, NY (US); ERIC LUBOW, NEW YORK, NY (US); RUSSELL BRADBERRY, NEW YORK, NY (US); DANIEL CROFT, WHITE PLAINS, NY (US); CARLOS ZENDEJAS, NEW YORK, NY (US); ZANAB HUSSAIN, NEW YORK, NY (US)

(73) Assignee: SIMPLEREACH, INC., NEW YORK, NY (US)

(21) Appl. No.: 13/650,025

(22) Filed: Oct. 11, 2012

Related U.S. Application Data
(60) Provisional application No. 61/545,927, filed on Oct. 11, 2011.

(51) Int. Cl. G06F 17/30

(52) U.S. Cl. 707/748; 707/E17.033

(57) ABSTRACT

A method for evaluating the impact of distributed digital content, including identifying content produced by a publisher on a first domain, determining user activity data associated with the content on one or more social networks, calculating an instantaneous score for each of the social networks for the content based on the user activity data associated with the content on the respective social network, calculating a velocity score for each of the social networks for the content, the velocity score comprising a rate of change of the instantaneous score for the respective social network, calculating a social value score for the content based on the velocity scores of the one or more social networks, and sending the social value score to a computer associated with the publisher.

### CROSS-REFERENCE TO RELATED APPLICATIONS

This application claims the benefit of U.S. Provisional Application No. 61/545,927 filed 11 Oct. 2011, which is incorporated in its entirety by this reference.

### TECHNICAL FIELD

This invention relates generally to the data analytics field, and more particularly to a system and method for evaluating and scoring the impact of digital content distributed through the Internet to one or more users.

### BACKGROUND

With the growth of the Internet for the distribution of commercial and personal information there is a corresponding growth of the use of the Internet to advertise and control information regarding various products or services. Many companies release advertising materials, promotional materials, press releases, and the like through the Internet, where the message can be quickly digested and disseminated through any number of channels. Unfortunately, once a message is published, there is little the advertiser or publisher can do to predict its impact in any objective fashion. Accordingly, there is a need in the art for a system and method for evaluating the impact of distributed digital content. In particular, there is a need for a system and method for scoring the efficacy of digital content as it propagates through various channels, search engines, and social networks on the Internet. Such a system and method is provided by the preferred embodiments of the present invention, described with reference to the appended drawings.

### BRIEF DESCRIPTION OF THE FIGURES

FIG. 1 is a schematic representation of the method for evaluating the impact of distributed digital content.

FIG. 2 is a schematic representation of a variation of the method.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

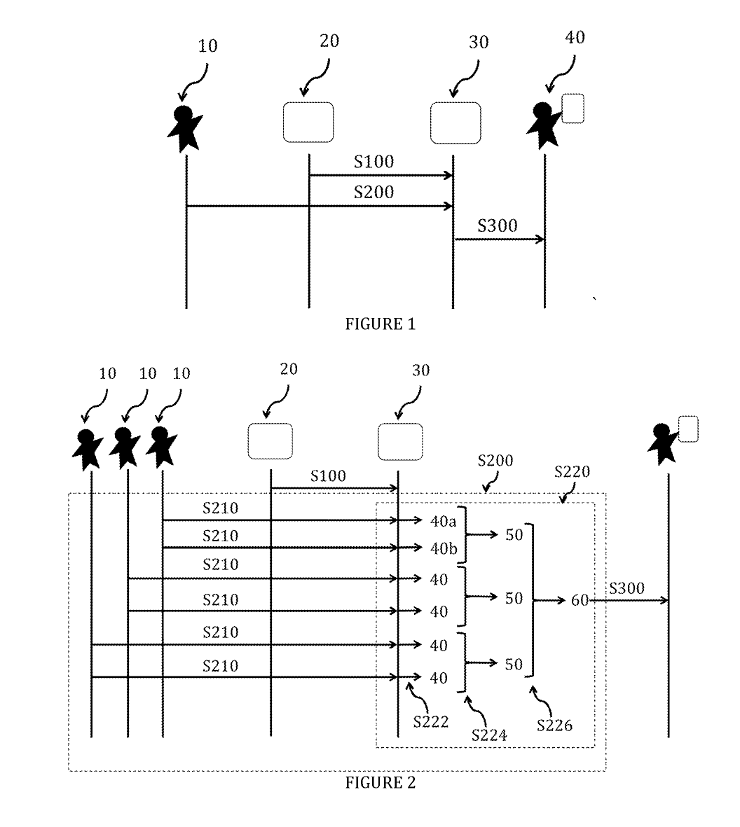

As shown in FIG. 1, the method for evaluating the impact of distributed digital content includes identifying digital content accessible from a remote computer S100, calculating a social value score of the digital content from user activity data from one or more online communities S200, and displaying a representation of the social value score at a device S300. The method functions to more accurately measure and quantify the social impact of a piece of content, providing a user with an understanding of the popularity or virality of their content by transforming various types of user activities on multiple disparate referral outlets (e.g. social networks, search engines, blog sites, etc.) into a social value score indicative of the social impact of the content at a given point in time. Furthermore, the method can function to predict the future social impact of a piece of content. The method preferably provides a content publisher with an understanding of the social impact of their content, wherein the content publisher can utilize the information in selecting future topics for content generation, in recommending content to a visitor, in monetizing advertisement space, or for any other suitable application. The method can alternatively provide an advertiser, a user of a social network, or any other suitable user 40 with an understanding of the social impact of their content. The method is preferably performed in real time or near real time, but can be performed at a predetermined frequency, performed in response to the determination of new user activities on the one or more online communities 10, in response to a new view of the content on the publisher domain, or at any other suitable frequency. The method can be entirely or partially performed between a computing system 30 and a user device.

Identifying digital content accessible from a remote computer S100 functions to identify, characterize, denote, and/or describe on or more items of digital content accessible from a remote computer. The content can be any suitable digital content, such as articles, advertisements, videos, images, and other electronically distributed media. The digital content preferably includes one or more forms of digital media, such as text, photos, videos, music, audio, or any other suitable content distributable through the Internet. Preferably, the text, photo, and/or video media can be arranged as articles or reviews and the like of the type distributed by a publisher and/or advertiser. The digital content is preferably accessible from a remote computer, wherein the remote computer can include a personal computer, laptop, tablet computer, smart phone, server or cloudbased computing platform, or any other combination or sub-combination of hardware, firmware and/or software configured for receiving and/or presenting distributed Internet content. The content is preferably hosted on a first domain 20 associated with the publisher of the content, wherein the first domain is preferably distinct from the online community domains. However, the content can alternatively be hosted on a domain of an online community, or hosted on any suitable Internet space.

Identifying digital content preferably includes identifying content produced by a publisher, more preferably, identifying content produced by a publisher on a first domain. The first domain is preferably an Internet domain or website identifier associated with the publisher, but can alternatively be an ISP identifying a system of servers or any other suitable denotation of a digital space associated with the publisher. The publisher preferably publishes one or more pieces of content on the first domain, wherein each piece of content is preferably associated with a unique identifier, such as a URL. Identifying content produced by a publisher preferably includes identifying the unique identifier, but can alternatively include identifying any other suitable identifier associated with the content. The content is preferably identified by a module associated with (e.g. located on) one or more pages of the first domain, wherein detection of a new unique identifier (e.g. URL) by the module can be the identification of content. Alternatively, content can be identified by monitoring the first domain for any new unique identifiers associated with content, by receiving a unique identifier associated with content, or by any suitable means. Identifying the content preferably additionally includes identifying a time associated with the content. Identifying a time associated with the content preferably includes requesting and/or receiving a time of publication or production for the content from the publisher (e.g. first domain), but can alternatively include recording the time at which the first instance of the unique content identifier was identified, or any other suitable means of determining a time associated with creation of the content.

Calculating a social value of the digital content S200 functions to quantify, characterize, determine and/or render an objective appraisal or valuation of the distribution and viewing of the digital content. The digital content for which the social value is calculated can be a URL or other identifier associated or non-associated with published content, content published on a publisher site, a post posted to a social network, or any other suitable digital item for which a social value can be calculated. Preferably, the social value of the digital content functions as a proxy for an economic value of the digital content to its advertiser and/or publisher. In another variation of the method of the preferred embodiment, the social value of the digital content can include time and geography aspects of the social value, thus permitting a recipient to more readily appreciate and/or estimate a future social value. For example, digital content that is distributed late in the evening in the United States might have a different social value trajectory than digital content distributed early in the morning in the United States, and likewise for other geographic locations. Accordingly, the social value of the method of the preferred embodiment can be appropriately scaled, normalized, or otherwise adjusted to account for differences in time and geography. Alternatively, any time and/or geographical dependencies of the social value of the digital content can be noted but not computed for the recipient, or noted and saved for subsequent customized computation.

As shown in FIG. 2, calculating a social value score of the digital content S200 preferably includes determining user activity data associated with the content for one or more online communities S210 and calculating a social value score for the content from the user activity data S220. The user activities are preferably performed by users of the online community, such as users of a social network. The social value score is preferably indicative of the rate of change in social interest in the content, but can alternatively be indicative of the instantaneous interest in the content relative to other pieces of content (e.g. published by the same publisher or across all monitored content), or indicative of any other suitable parameter. Calculating a social value score from the user activity data S220 preferably includes calculating, for the content, an instantaneous score 40 for each online community from user activity data associated with a time period S222, determining a velocity score 50 for the online community from two or more instantaneous scores S224, and calculating the social value score 60 from the velocity scores for the plurality of online communities S226. Calculating the social value score S200 can additionally and/or alternatively include calculating the social value score from the number of referrals to the content from a single online community or over a plurality of online communities (e.g. an overall number of referrals to the content or the total number of referrals to the content from select online communities). Calculating the social value score S200 can additionally and/or alternatively include calculating the social value score from the overall number of views of the content and the number of referrals to the content. However, calculating a social value score from the user activity data S200 can alternatively include calculating the social value score from an aggregation of weighted user activity data associated with the content from a plurality of online communities, or any other suitable method of calculating a relevant social value score. However, any other suitable method of calculating the social value score can be used.

Determining user activity data associated with the content for one or more online communities S210 functions to identify, characterize, denote, and/or describe the social impact of the content on an online community. The online communities are preferably social networks, but can alternatively be search engines, blog sites or any other suitable website capable of directing users to the content. While user activity data is preferably determined for each of a plurality of online communities, user activity data can alternatively be determined for a single online community or any suitable number of online communities. User activity data is preferably determined for a predetermined set of online communities. Alternatively, user activity data can be determined only for the online communities that have directed users to the content, wherein online communities are preferably added to a list of monitored online communities when the online community is detected to have directed traffic to the content. In this variation, determining data for user activity associated with the content preferably additionally includes identifying or determining an online community. Identifying an online community preferably includes determining the source of a referral to the content from metadata associated with the referral (e.g. data from the URL, etc.), wherein an identifier for the online community (e.g. a URL, name, or other suitable identifier) can be received from the first domain or determined on the first domain by a native application or widget. The online community can alternatively be identified in any suitable manner.

The user activities for which data is determined preferably include references and actions. References preferably include content generated by users of the online community that reference the content. For example, references can include posts that link to the content through a unique identifier, posts that reference a portion of the content (e.g. quotes the content, utilizes an image from the content, etc.), or any other content that directly or indirectly references the content. References preferably at least include both original posts and redistribution of posts (e.g. shares, retweets, etc.), and can additionally include any other suitable reference to the content. Actions preferably include social actions associated with the content, wherein the actions are afforded to users by the capabilities or affordances of the online community. For example, actions can include reference redistribution (e.g. shares, retweets, etc.), positive indications of interest in the reference or content (e.g. likes, pins, tweets), comments on the reference, or any other suitable action afforded by the online community. Actions are preferably performed on references, and thereby associated with the content through the respective reference, but can alternatively be associated with the content in any suitable manner. User activity data can additionally include the number of referrals from the social network, which includes the number of views that are directed to the content from the social network.

The data determined for the user activity preferably includes user activity parameters or characteristics, and can include the type of user activity, the volume of user activity, the time of user activity, the user associated with a user activity, or any other suitable parameter. For example, data for user activity associated with the content can include the total volume of user activity on the online community, the types of user references, the user that generated each reference, the number or volume of references on the online community, the time of content reference, the types of user actions, the user that generated each user action, the time of user action, and the number or volume of user actions on the online community.

Determination of user activity data for the online community S210 preferably includes receiving data indicative of user activity on the online community. Data can be received periodically, received when a user activity parameter changes, received in response to a request from a device associated with the publisher, or received at any suitable frequency. Data indicative of user activity on the online community can be received from the online community, wherein the online community can send the data to a computing network performing the method or provide access to online community site data. Alternatively, data indicative of user activity on the online community can be received from a module or widget, wherein receiving data indicative of user activity on the online community preferably additionally includes monitoring the online community by the module or widget and scraping, extracting, or collecting identified user activity data from the online community. Alternatively, data indicative of user activity on the online community can be received from the account of a user associated with the online community (e.g. the user of a social network), wherein receiving data indicative of user activity further includes receiving user authorization for access to data associated with a user account. Alternatively, data indicative of user activity on the online community can be received from the publisher or from a module or widget on the publisher site, wherein the module or widget determines or extracts the user activity data and the appropriate online community from data (e.g. metadata) associated with a referral to the content.

Determining an instantaneous score for the online community based on the user activity data S222 functions to calculate, compute, determine, and/or present a measure of the prevalence of the content within a online community at a given point in time. The instantaneous score is preferably determined from the user activity data associated with the content, more preferably from the volume of user activity data, weighted or discounted by activity type. The instantaneous score can be an aggregation or sum of the discounted user activity volumes, but can alternatively be a product, quotient, or any other result of any suitable calculation of the user activity volumes. The instantaneous score can additionally be determined based on the users that generated the user activity, wherein actions associated with the content by key influencers (e.g. as determined by the number of followers, number of connections, number of responses, number of sharing actions on their content, etc.) can impart higher instantaneous scores and/or higher weights to the associated user action. In this variation, the method can additionally include user consolidation, wherein multiple user actions taken by a single user on multiple online communities can be consolidated into and treated as a single user action. The instantaneous score can additionally be based on the volume of traffic directed to the content by the online community, wherein the instantaneous score preferably varies proportionally with the directed traffic volume, but can alternatively be influenced by the directed traffic volume in any suitable manner. The instantaneous score is preferably associated with a time, such as the time at which the user activity data was retrieved or sent, or the time at which the instantaneous score is computed.

Determining a velocity score for the content for each of the one or more online communities S224 functions to calculate, compute, determine, and/or present a potential virality (positive velocity) of the digital content by measuring a rate at which the digital content is being propagated through the various online communities. Additionally, determining a velocity score for the content can function to predict a lifespan for a particular item of digital content in the event that a computed velocity is negative. Velocity scores are preferably determined separately for distinct online communities, but can alternatively be determined for the plurality of online communities as a whole, or determined for any suitable subset of the plurality of online communities. The velocity score is preferably determined from the user activity data for the respective online community, but can alternatively and/or additionally be determined from content data, such as the total number of views, or any other data indicative of content propagation or social impact. More preferably, the velocity score is determined from two or more instantaneous scores for the online community based on the user activity data related to the content.

The velocity score for the online community is preferably determined from a first and a second instantaneous score (40a and 40b, respectively). The first and second instantaneous scores are preferably consecutive instantaneous scores, but can alternatively be any suitable instantaneous score associated with two distinct times. Alternatively, determining the velocity score for a online community can include determining the velocity score from a difference in user activity volume between a first time point and a second time point. Alternatively, the velocity score for the content for a online community can be determined from the rate at which the online community refers users to the content or determined in any suitable manner. However, the velocity score can be determined in any suitable manner.

The method can additionally include determining an acceleration score for the online community from the user action data, which can function to calculate, compute, determine and/or present a rate of change of the virality of the content. More preferably, the acceleration score can be used in calculating or estimating a lifetime of the content popularity, particularly when the acceleration score is negative (e.g. content is being shared or referenced at a decreasing rate). The acceleration score is preferably determined for a specific online community for a specific piece of content, and can be indicative of the lifetime of the content on the online community (e.g. the duration of content popularity on a social network). The acceleration score is preferably determined from a first and a second velocity score, more preferably from two consecutive velocity scores. However, the acceleration score can be determined in any suitable manner from the user activity data for the online community. The acceleration scores from multiple online communities can additionally be aggregated to determine an overall lifetime of the content (e.g. the duration of general content popularity).

Calculating the social value score for a piece of content from the velocity scores for the plurality of online communities S226 functions to render a numerical or other human-readable valuation of the digital media for delivery to the user. A social value score is preferably calculated for each piece of content published by the publisher on the first domain. The social value score is preferably calculated from the velocity scores, and is preferably based on an aggregation of the velocity scores associated with a given period of time for all of the distinct social online communities. The social value score can additionally be calculated from the total volume of traffic or views for the content on the first domain (e.g. total number of unique views, page visits, etc.), wherein the total traffic volume can be provided by or derived from the first domain. Furthermore, the social value score can additionally be degraded at a decay rate, wherein the social value score is preferably degraded (e.g. decreased) over time. The decay rate is preferably predetermined, but can alternatively be dynamically determined based on the acceleration score of other online communities of the content. The social value score can be calculated for a given time period, wherein the social value score is representative of the impact at the given time period. Alternatively, the social value score can be calculated from two time periods, more preferably from the velocity scores for all the online communities from two consecutive time periods, wherein the social value score is representative of the change in impact between the two time periods. Alternatively, each distinct online community can have a social value score dependent on the respective velocity score of the online community. Preferably, the social value score can be calculated via a non-linear function, such as for example an exponential or logarithmic function. Alternatively, the social value score can be calculated based on social value scores for other pieces of content produced by the producer. However, the social value score can be calculated in any other suitable manner.

While the social value score can be directly calculated from the velocity scores for each online community, the social value score preferably calculated from discounted velocity scores, wherein the velocity scores are discounted or weighted according to the respective online community. Discounting the velocity scores for each of the plurality of references can normalize or standardize the relative value of any particular velocity score from the one or more online communities. As an example, the relative value of a pair of referrals from two social networking sites might be different, and discounting the velocity scores functions to ensure that the overall social value of the digital content is not skewed one way or another by a feature of the social online community as opposed to a feature of the digital content. The discount factor is preferably predetermined for each online community, but can alternatively be determined in real time based on the instantaneous score of the online community relative to other online communities, the velocity score of the online community relative to other online communities, or any other suitable measurement of popularity of the content on the online community relative to other online communities.

Social value scores are preferably determined for multiple pieces of content published by a publisher, more preferably all pieces of content published by the publisher, wherein the previously described steps are preferably repeated for each piece of content. However, social value scores can alternatively be determined for a single piece of content, or for any suitable number of content.

Displaying a representation of the social value score to a computer associated with a user S300 functions to create interactive human-readable information that permits a user, more preferably the publisher and/or advertiser to see in real-time, near real-time, and/or historically, the instantaneous and/or predicted social value associated with the digital content. The social value score is preferably displayed alongside an indicator associated with the content, such as the content title, publish time, or any other suitable data associated with the content. The social value score can additionally be displayed with additional optional metrics such as weighted and maximum Klout scores, a number of Facebook likes, and a number of tweets. Other suitable additional metrics can be used and/or presented to the user as part of or in addition to the computed social value. The representation of the social value score is preferably interactive, such that a user can drill down into certain data points or roll up other data points. The representation of the social value score can also be linked to the content. The representation of the social value score is preferably deliverable to the user in real time or near real time such that the user can directly monitor the social impact of the digital content. The social value score can also be utilized as part of a bidding exchange. For example, a third party, such as an advertiser, can access the social value score of the content and bid, in substantially real time, on advertising space associated with the content. Alternatively or additionally, the social value score can be retained and is deliverable to the user for historical and/or comparative research regarding the digital content. The social value scores are preferably calculated by a calculation module and sent by display module of the one or more servers of the computer system to a device associated with the publisher or user, wherein the social value scores can be sent with or without display instructions, wherein the device displays a representation of the social value score. Alternatively, the device can calculate the social value scores with a calculation module and display a representation of the social value score by a display module associated with the device.

The social value scores of multiple pieces of content published by a user can additionally be aggregated into a social value report, such that the user can engage in real time or near real time comparative analysis of two or more digital content items. Alternatively, the social value scores and any associated information can be presented to a user individually. The social value report is preferably presented as an ordered list including social value scores for multiple pieces of content for the publisher, wherein the multiple pieces of content are preferably published on the same domain. Alternatively, the representation can include a presentation of the social value report in graphical form, including a map showing some or all locations from which the social value data is derived. Additionally, the representation can include additional aspects such as a scale indicating the relative value of each reference point shown on the map. The social value report is preferably generated and sent by a server to a device associated with the user, but can alternatively be aggregated and displayed by the device, wherein the device can calculate or receive individual social value scores associated with various pieces of content.

The method can additionally include detecting erroneous data from the online communities, which can function to detect inaccurate data that should be excluded from social value score calculation. Erroneous data detection can be performed automatically or manually, and is preferably performed whenever a new piece of user activity data is received from a online community, but can alternatively be performed at predetermined frequencies, in response to a trigger event (e.g. notification from the publisher), or in response to any suitable detection event. In one variation, detecting erroneous data includes comparing recently received user activity data against past user activity data from the online community for the content. Sudden changes in consecutive user activity data can be indicative of erroneous data. For example, the recently received user activity data can be erroneous data if said user activity data is substantially lower than the last received user activity data. In another variation, detecting erroneous data includes comparing the user activity data received from the online community to traffic data from the publisher. For example, if Facebook indicates that there are 500 likes associated with the content, but the publisher only shows three click-throughs to the content from Facebook, the Facebook user activity data is most likely erroneous. In another variation, detecting erroneous data includes comparing the recently received user activity data against past user activity data for the online community for multiple pieces of content, wherein the multiple pieces of content can be from a single publisher or from a plurality of publishers. The recently received user activity data can be tagged as erroneous when the data substantially matches known patterns of erroneous user activity data receipt from the online community. In another variation, detecting erroneous data includes comparing the velocity score calculated from the recently received user activity data for the content against the velocity scores of other online communities for the same piece of content. The recently received user activity data can be tagged as erroneous if the respective velocity score is substantially different from the velocity scores of the other online communities, or is substantially different from an estimated velocity score for the online community based on the velocity scores of the other online communities (e.g. if the content is trending at a first rate on Twitter, it is expected to be trending at a second rate, derived from the first rate, on Facebook, wherein the second rate derivation can be based on historical data). However, erroneous data can be detected in any other suitable manner.

In response to the detection of erroneous data, the erroneous data is preferably removed from the social value score calculation. The method can additionally include estimating the current user activity data for the content for the online community. In one variation, current user activity estimation can be based on historical user activity data from the online community. For example, the most recent velocity score for the online community can be used to extrapolate the current user activity for the online community. In another variation, current user activity estimation can be based on historical user activity data from the online community and current user activity data from other online communities. For example, the velocity scores of the other online communities can be used to extrapolate the current user activity from the last valid user activity data for the online community of interest.

The method can additionally include calculating a global score for each online community, which functions to calculate, compute, or otherwise determine a score indicative of the level of interaction that users of a online community have with the content or posts associated with the content. A global score is preferably determined for each online community, and is preferably determined from all the instantaneous scores and/or velocity scores for the online community, across multiple pieces of content. In the calculation, each of the instantaneous scores and/or velocity scores can be weighted or discounted based on the publisher of the content, the social value score of the content, or any other suitable parameter, such that the global scores are normalized for content that was extremely popular.

The method can additionally include adjusting the recommended content on the first domain, which functions to generate a recommendation for a second piece of content that is published by the same publisher on the content page for the first piece of content. The recommended content is preferably a second piece of content distinct from the first. The recommended content on the first content page is preferably dynamically adjusted based on the relative social value scores of the other content generated by the publisher, wherein the content with the highest social value score is preferably served as the recommended content. An actionable representation of the recommended content, such as an image, title, or any other suitable representation of the recommended content, is preferably displayed on the page for the first content, but the recommended content can alternatively be recommended in any suitable manner.

The method can additionally include analyzing the user activity data and the content to extract influencing parameters, which functions to determine which parameter of the content drove social impact and/or popularity. In one variation of the method, influencing parameters include keywords or topics of interest to the users. In this variation, user comments on user reference (e.g. posts on a social network including a content identifier) are analyzed to determine which keywords or phrases from the content was quoted or referenced. In another variation of the method, influencing parameters include parameters of the content, including but not limited to the body of the content. In this variation, the content with the highest historical social value scores are analyzed to extract common themes, keywords, topics, article structures, layouts, ratios of images to text, or any other suitable content parameter of interest. However, parameters that influence popularity can be determined or extracted through any other suitable method.

The method of the preferred embodiment and variations thereof can be performed on or by a computer network comprising one or more servers, computers, or any other suitable computing device, a computing system, and/or a computer program product embodied in a computer-readable medium storing computer-readable instructions. The system can include one or more networked devices configured for the receipt and presentation of content to a user as well as one or more servers and/or content distribution modules configured to store and distribute the content to one or more users. Any computer readable instructions are preferably executed by computer-executable components integrated with one or more of a user device or a server. Suitable user devices can include a personal computer, laptop computer, a tablet computer, a smart phone, personal digital assistant, portable music player and the like. Suitable servers can include standalone local servers, personal computers, server clusters or farms, or any suitable combination thereof. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention defined in the following claims.

We claim:

1. A method for evaluating the impact of distributed digital content, comprising:
at a computer network:
identifying content produced by a publisher on a first domain;
determining user activity data associated with the content on one or more social networks, each social network located on a domain different from the first domain;
calculating an instantaneous score for each of the social networks for the content based on the user activity data associated with the content on the respective social network;
calculating a velocity score for each of the social networks for the content, the velocity score comprising a rate of change of the instantaneous score for the respective social network;
calculating a social value score for the content based on the velocity scores of the one or more social networks; and
sending a representation of the social value score to a computer associated with the publisher.

2. The method of claim 1, wherein determining the user activity data associated with the content comprises determining the volume of references to the content on the social network.

3. The method of claim 2, wherein each reference comprises a unique identifier associated with the content.

4. The method of claim 2, wherein determining the user activity data associated with the content further comprises determining the volume of user actions on the reference, wherein the user actions are afforded by affordances of the social network.

5. The method of claim 4, wherein user actions comprise generating a second reference to the content from the first reference.

6. The method of claim 4, wherein user actions comprise commenting on the reference.

7. The method of claim 4, wherein user actions comprise a positive indication of interest in the content.

8. The method of claim 4, wherein calculating a value score for each of the social networks based on the volume of activities comprises calculating the value score based on a weighted volume of user actions and a weighted volume of referrals.

9. The method of claim 1, wherein calculating an instantaneous score for a social network for the content is further based on a volume of referrals to the content from the social network.

10. The method of claim 1, wherein calculating a velocity score for a social network comprises calculating the velocity score from a first and a second instantaneous score for the social network for the content, wherein the first and second instantaneous scores are associated with distinct time periods.

11. The method of claim 1, wherein calculating the velocity score for a social network for the content further comprises calculating an acceleration score for the social network for the content, comprising calculating a rate of change between a first and a second consecutive velocity score.

12. The method of claim 11, wherein calculating the velocity score for a social network for the content further comprises calculating a lifetime of the content on the social network when the acceleration score is negative.

13. The method of claim 1, wherein calculating the social value score for the content comprises weighting each velocity score with a weight associated with the respective social network and computing the social value score from the weighted velocity scores.

14. The method of claim 1, wherein calculating the social value score for the content is further based on a volume of views of the content on the first domain.

15. The method of claim 1, wherein calculating the social value score for a social network for the content further comprises degrading the social value score at a predetermined decay rate.

16. The method of claim 1, wherein calculating the social value score for the content comprises comparing the velocity score of a first social network with the velocity score of a second social network, wherein, based on the comparison:
the social value score for the content is calculated from the velocity score of the first social network when the velocity scores of the first and second social networks are similar; and
the velocity score of the first social network is excluded from the calculation of the social value score for the content when the velocity scores of the first and second social networks are substantially different.

17. The method of claim 1, further comprising calculating the social value score for a plurality of content produced by a publisher; ordering the plurality of content according to the social value score, and displaying the associated social value score and an identifier for a each of a subset of the plurality of content on a computer associated with the publisher.

18. The method of claim 17, further comprising dynamically recommending a second piece of content, disparate from the first piece of content, on a page of the first domain that displays the first content, wherein the second piece of content has the highest social value score from the plurality of content.

19. A method for determining interest in distributed digital content, comprising:
at a computer system:
identifying a content identifier for content published on a first domain;
periodically determining a volume of activities associated with the content identifier on a plurality of social networks, each social network located on a domain different from the first domain;
calculating an instantaneous score for the content for a social network in response to a determination of the volume of activities associated with the content identifier on the social network, the instantaneous score calculated from the determined volume of activities and associated with a time stamp;
calculating a velocity score for the content identifier for the social network in response to the calculation of the instantaneous score, comprising calculating the velocity score from a first and second instantaneous score;
calculating a social value score for the content identifier based on an aggregation of the velocity scores for the plurality of social networks, each velocity score weighted by a predetermined weight assigned to the respective social network; and
sending instructions for displaying a representation of the social value score to a display module.

20. The method of claim 19, wherein the volumes of activities associated with the content identifier on each of the plurality of social networks are determined at a predetermined frequency.

21. The method of claim 19, wherein the volume of activities associated with the content identifier comprise a volume of posts referencing the content; a volume of actions, afforded by the respective social network, on posts referencing the content; and a volume of click-throughs to the content from posts referencing the content.

22. The method of claim 21, wherein posts referencing the content identifier comprise posts including a content identifier linked to the content.

23. A method for evaluating the impact of published content, comprising:
by a computer system:
identifying a content identifier unique to a piece of content published on a first domain;
periodically determining a rate of change of a volume of activity associated with the content identifier on each of a plurality of social networks, each social network located on a domain different from that of the first domain;
calculating a social value score for the content from the rates of change of each of the plurality of social networks, each rate of change weighted by a predetermined weight associated with the respective network;
displaying the social value score for the content on a device.

24. The method of claim 23, further comprising calculating a social value score for each of a plurality of content published on the first domain and ordering the plurality of content into an ordered list according to the respective social value score, wherein displaying the social value score for the content on a device comprises displaying a subset of the ordered list on the device.
